(19) United States
(12) Patent Application Publication
(10) Pub. No.: US 2014/0359275 A1
(43) Pub. Date: Dec. 4, 2014

(54) Method And Apparatus Securing Traffic Over MPLS Networks

(71) Applicant: Certes Networks, Inc., Pittsburgh, PA (US)

(72) Inventors: Ganesh Murugesan, Bangalore (IN); Todd L. Cignetti, Ashburn, VA (US)

(73) Assignee: Certes Networks, Inc., Pittsburgh, PA (US)

(21) Appl. No.: 14/254,144

(22) Filed: Apr. 16, 2014

Related U.S. Application Data
(60) Provisional application No. 61/828,515, filed on May 29, 2013.

(51) Int. Cl. H04L 29/06

(52) U.S. Cl. CPC H04L 63/0428
USPC 713/153

(57) ABSTRACT

Multi-protocol label switching (MPLS) data is typically sent non-encrypted over MPLS-based networks. If encryption is applied to MPLS data frames and MPLS labels are encrypted, each node receiving any of the MPLS data frame would have to perform decryption in order to direct the data frames to a next node, therefore resulting in extra processing and data latency. According to an example embodiment, encryption and decryption mechanisms for MPLS data include encrypting/decrypting payload data while keeping the MPLS labels in the clear (i.e., unencrypted). A MPLS encryption label is also employed within the MPLS label stack to indicate that encryption is applied. The MPLS encryption label is inserted in the MPLS label stack when encrypting the payload and is removed when decrypting the payload.

### RELATED APPLICATION(S)

This application claims the benefit of U.S. Provisional Application No. 61/828,515, filed on May 29, 2013. The entire teachings of the above application(s) are incorporated herein by reference.

### BACKGROUND OF THE INVENTION

Multi-protocol label switching (MPLS) based networks are gaining attraction and interest among network providers and their respective customers. MPLS-based networks typically enable migration of multiple services over a common high speed backbone.

### SUMMARY OF THE INVENTION

According to an example embodiment, a method and corresponding apparatus for multi-protocol label switching (MPLS) data encryption, comprise: encrypting a payload of a data frame while keeping a MPLS label stack of the data frame non-encrypted; and inserting a MPLS encryption label, indicative of encryption of the payload, within the MPLS label stack of the data frame. A determination may further be made regarding whether a received data frame is a MPLS data frame. As such, encrypting the payload and inserting the MPLS encryption label are performed upon determining that the received data frame is a MPLS data frame.

According to another example embodiment, a method and corresponding apparatus for MPLS data decryption, comprise: parsing a MPLS label stack of the MPLS data frame, and upon determining that the parsed MPLS label stack includes a MPLS encryption label, indicative of encryption of a payload of the MPLS data frame, decrypting the payload and removing the MPLS encryption label from the MPLS label stack. A determination may further be made regarding whether a received data frame is a MPLS data frame. As such, parsing the MPLS label stack, decrypting the payload, and removing the MPLS encryption label are performed upon determining that the received data frame is a MPLS data frame.

In particular, the subject received data frame is a layer-two (L2) data frame.

A computer program product and/or processor with configured memory carryout or otherwise implement the foregoing methods and apparatus in a communication network.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram illustrating a communication network according to at least one example embodiment.

FIG. 2A is a graphical representation of a non-encrypted MPLS data frame 200a, according to at least one example implementation.

FIG. 2B is a graphical representation of a MPLS data frame encrypted according to at least one example embodiment.

FIG. 3A is flowchart illustrating a method for MPLS data encryption, according to at least one example embodiment.

FIG. 3B is a flowchart illustrating a MPLS data decryption method, according to at least one example embodiment.

FIGS. 4A and 4B are graphical representations of different encrypted MPLS data frames and the respective non-encrypted MPLS data frames in embodiments of the present invention.

### DETAILED DESCRIPTION OF THE INVENTION

A description of example embodiments of the invention follows.

Multi-Protocol Label Switching (MPLS) is a shared network service enabling switching of data traffic based on MPLS labels inserted in data frames, or packets. Information in MPLS label(s) is used by switches of a MPLS-based network to forward data frames, or packets, to a next node, or switch, in the MPLS-based network. Switches in a MPLS-based network may also perform label swapping. Specifically, a switch may remove a MPLS label from an incoming MPLS data frame or packet and insert a new MPLS label. The inserted MPLS new label is used by the next node or switch receiving the MPLS data frame or packet.

A MPLS-based network may be technically viewed as a virtual private network (VPN). However, a MPLS-based network may not actually be private but it only mimics privacy by logically separating data with MPLS labels. In particular, a MPLS-based provider network, typically, handles data traffic from thousands of different customers and users, including traffic from other carriers and the Internet, at any given moment. The data traffic from the different customers and users flows across a common infrastructure, e.g., switches, of the MPLS-based provider network.

Even if MPLS-based networks were to be perceived or accepted as private networks, as alleged by some network providers, such networks do not provide secure communication media. While data traffic streams, in a MPLS-based network, are typically separated based on respective MPLS labels, the same mechanism used to separate data traffic streams, e.g., MPLS labels, may also be used by hackers or intruders to identify targets of interest when trying to intercept data traffic streams. Furthermore, controls around provisioning and management modules in MPLS-based networks, as well as gateways between the Internet and MPLS networks, do not prevent data theft. In fact, unauthorized access to data traffic streams may occur right at the MPLS backbone. In addition, the use of Netflow or J-Flow, by network providers, to identify malicious activities does not substitute preventive security measures. That is, the identification of malicious activities may be used for post-event notification but would not help in preventing such malicious attacks. Also, typical MPLS VPNs offer logical data traffic separation as data packets traverse over the common MPLS network. However, the logical separation does not secure the data content of the data packets. In fact, data content is visible to any one on the untrusted part of the MPLS network, e.g., via wiretapping or snooping. Transmitting data unsecure over the MPLS network is a severe fault in compliance requirements where data security is mandatory.

The security of data traffic in MPLS-based networks is a real and important issue for customers and users. For example, for companies sending data traffic across an MPLS-based network, any potential unauthorized access to their respective data by intruders puts such companies and their customers at risk. The security solutions may also be mandated by compliance requirement, e.g., from a government agency. In the following, embodiments of a mechanism for securing data traffic in a MPLS-based network according to principles of the present invention are described.

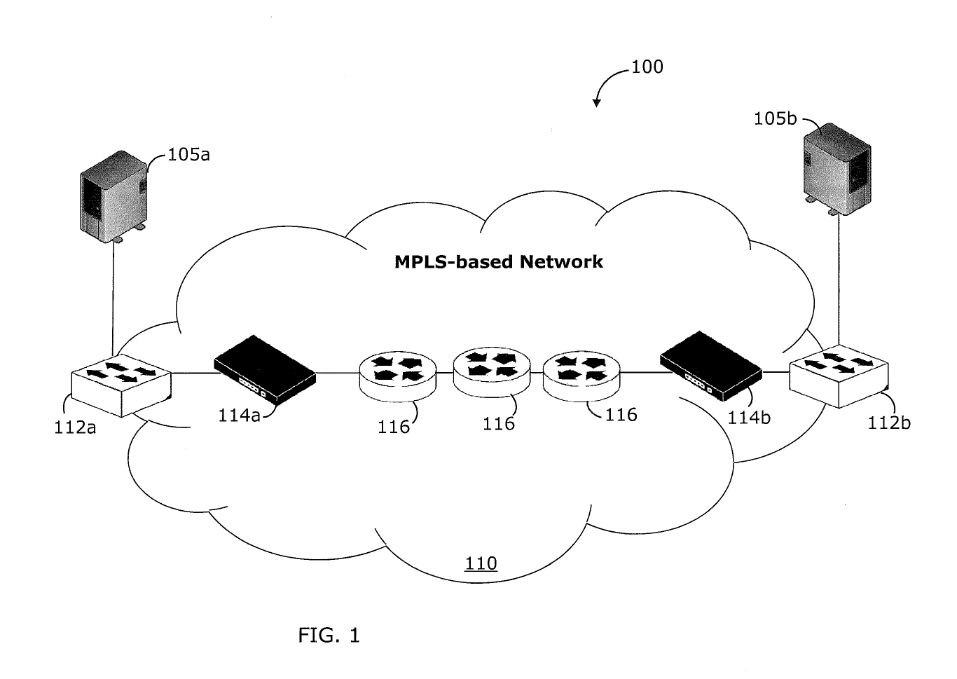

FIG. 1 is a diagram illustrating a communication network 100 according to at least one example embodiment. The communication network 100 includes a MPLS-based network 110 that is coupled to a plurality of customer networks. Specifically, one or more provider edge routers, e.g., 112a-b, associated with the MPLS-based network 110 are coupled to customer routers, e.g., 105a-b, associated with customer network(s). According to at least one example implementation, provider edge routers, e.g., 112a-b, insert MPLS labels into data frames received from customer networks. The MPLS-based network 110 includes encryption/decryption devices, e.g., 114a-b, configured to encrypt, or decrypt, MPLS data frames while keeping MPLS labels un-encrypted. According to at least one example embodiment, the encryption/decryption device, e.g., 114a or 114b, is also configured to insert a MPLS encryption label, when encrypting a MPLS data frame, to indicate that the MPLS data frame is encrypted. Given that the MPLS labels are not encrypted, each provider backbone router 116 may direct/forward MPLS data frames, or packets, to a next node or router in the MPLS network 110 without decrypting the MPLS data frame or packet. Within the MPLS network 110, a MPLS data frame or packet is forwarded from one entity to another entity based on information in the respective MPLS label(s).

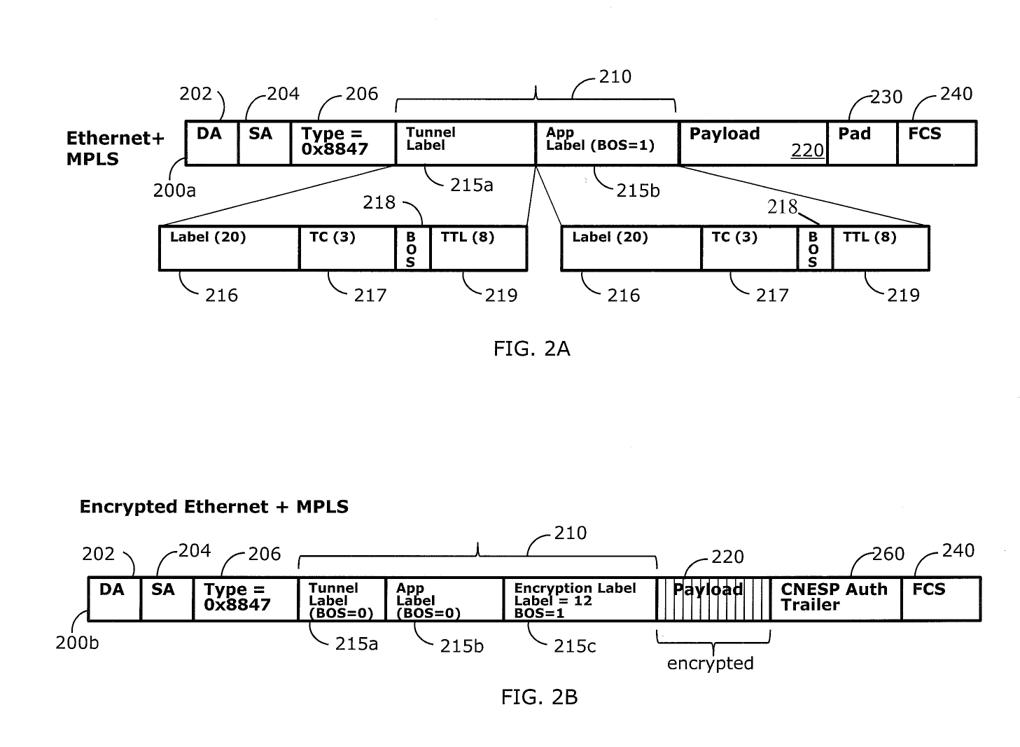

FIG. 2A is a graphical representation of a non-encrypted MPLS data frame 200a, according to at least one example implementation. The data frame 200a includes a destination address entry 202, a source address entry 204, and an entry 206 indicative of an Ethernet type. The MPLS data frame 200a includes a MPLS label stack 210 with two MPLS labels 215a and 215b, e.g., a tunnel label 215a and application label 215b. A MPLS label stack 210 usually includes one or more MPLS labels (215 generally). The tunnel label 215a is typically the label at the top of the MPLS label stack 210. Information in the tunnel label 215a is used to switch the data through the MPLS network 110 from one provider edge router, e.g., 112a or 112b, to another remote provider edge router, e.g., 112a or 112b. The application label 215b typically resides below the tunnel label 215a within the MPLS label stack 210. Information in the application label 215b is typically used to identify, at the remote end node of the MPLS network 110, e.g., provider edge router 112a or 112b, a respective application so that the remote node knows how to process the data frame. The lack of an application label 215b in the MPLS label stack 210 may be an implicit assumption that the data carried by the MPLS data frame or packet 200a is an Internet Protocol version 4 (IPv4) packet.

An example application for FIG. 2A is transporting multiple-services over the MPLS network 110. For example, a service provider owning a MPLS backbone network may offer Ethernet, Asynchronous Transfer Mode (ATM) and Frame-Relay services over the common MPLS network. When these services are created, appropriate MPLS application labels 215b are exchanged between the edge routers 112a, 112b and mapped to each of these services. This allows the terminating edge device to know the application traffic, e.g., Ethernet, ATM or Frame-Relay, and to switch according to the specifications of that data frame. However, within the MPLS backbone network, all these packets are processed as MPLS packets.

A MPLS label, e.g., 215a or 215b, is four Bytes, or 32 bits, long. The MPLS label includes a 20-bits label value entry 216, a three-bits traffic class entry 217, a one-bit bottom of stack (BOS) entry 218, and an eight-bits time-to-live (TTL) entry 219. The BOS entry 218 indicates whether or not the respective MPLS label, e.g., 215a or 215b, is the last entry in the MPLS label stack 210. For example, if in a given MPLS label 215a, 215b the BOS entry 218 is set to one, then the given MPLS label, e.g., 215a or 215b, is the last label in the MPLS label stack 210.

The MPLS data frame or packet 200a also includes a data payload 220. The MPLS data frame or packet 200a may also include a zero-padding segment 230 and a frame check sum (FCS) entry 240.

FIG. 2B is a graphical representation of a MPLS data frame 200b encrypted according to at least one example embodiment. In the MPLS data frame 200b, the data payload 220 is encrypted while the MPLS label stack 210 is un-encrypted. Also, compared to the non-encrypted MPLS data frame 200a, the MPLS label stack 210 in the encrypted MPLs data frame 200b includes an encryption MPLS label 215c with information indicating that the data payload 220 in the MPLS data frame 200b is encrypted. According to at least one example embodiment, the encryption MPLS label 215c is inserted at the end of the MPLS label stack 210. As such, the BOS entry 218 is set to zero in all MPLS labels, e.g., 215a and 215b, except in the MPLS encryption label 215c where it is set to one indicating that the MPLS encryption label is the last MPLS label in the MPLS label stack 210. The encrypted MPLS data frame 200b may further include an authentication trailer 260 with data used to authenticate the encrypted MPLS data frame 200b.

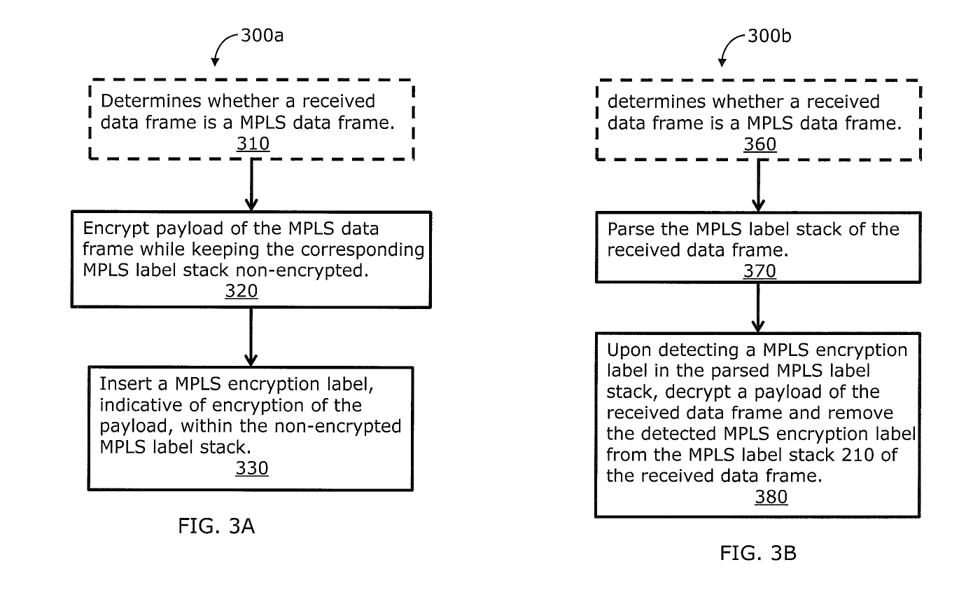

FIG. 3A is a flowchart illustrating a method 300a of MPLS data encryption, according to at least one example embodiment. At block or step 310 a network device, e.g., 114a or 114b, determines whether a received data frame is a MPLS data frame 200a, 200b. For example, the network device 114a, 114b may check whether or not the received data frame includes a MPLS label stack 210. Upon determining that the received data frame is a MPLS data frame 200a, 200b, the network device 114a, 114b encrypts, at block or step 320, the payload 220 of the received data frame while keeping the MPLS label stack 210 non-encrypted, and inserts, at block/step 330, a MPLS encryption label 215c, indicative of encryption of the payload, within the non-encrypted MPLS label stack 210 of the MPLS data frame 200b.

In inserting the MPLS encryption label 215c, the network device 114a, 114b may scan the MPLS label stack 210 of the MPLS data frame 200a to determine a last label in the MPLS label stack 210. The network device 114a, 114b then inserts the MPLS encryption label 215c, indicative of encryption of the MPLS payload 220, following the last label determined. As such, the inserted MPLS encryption label 215c becomes the last MPLS label in the MPLS label stack 210. Accordingly, the network device 114a, 114b sets a BOS entry 218 associated with the MPLS label of the MPLS data frame 200b to indicate that the inserted MPLS encryption label 115c is the last MPLS label in the MPLS label stack 210. For example, the network device may set the BOS entry 218 of the MPLS encryption label 215c to 1 and the other BOS entries 218, associated with other MPLS labels in the MPLS label stack 210, to 0.

In encrypting the payload 220, an encapsulating security payload (ESP) header is further inserted in the MPLS data frame 200b. For example, the ESP header may be inserted between the MPLS label stack 210 and the encrypted payload 220. Upon encrypting the data payload 220 and inserting the MPLS encryption label 215c, the network device 114a, 114b may then transmit/forward the encrypted data frame or packet 200b over the MPLS-based network 110 to another node in the MPLS-based network.

By keeping the MPLS label stack 210 non-encrypted, network entities, e.g., provider backbone routers 116, are able to use the information in the MPLS labels to forward the MPLS data frame or packet 200b to a next node without performing decryption. In addition, network entities receiving the encrypted MPLS data frame or packet 200b may easily determine that the received MPLS data frame includes encrypted data based on the presence of the MPLS encryption label 215c in the MPLS label stack 210. For example, an encryption/decryption device, e.g., 114a or 114b, may determine whether or not decryption is to be applied to a MPLS data frame or packet, e.g., 220a or 200b, based on the absence or presence of a MPLS encryption label 215c within the corresponding MPLS label stack 210.

According to at least one example embodiment, determining whether a received data frame is a MPLS data frame at block 310 may be optional or may be performed by a different device than the network device performing payload encryption. In other words, if every received data frame received by the network device, e.g., 114a or 114b, is a MPLS data frame 200a, 200b, the network device may encrypt the payload 220 of the received data frame and insert the MPLS encryption label 215c without checking whether or not the received data frame is a MPLS data frame.

FIG. 3B is a flowchart illustrating a MPLS data decryption method, according to at least one example embodiment. At block or step 360, a network device, e.g., 114a or 114b, receiving a data frame determines whether the received data frame is a MPLS data frame 200a, 200b. Upon determining that the received data frame is a MPLS data frame 200a, 200b, the network device parses, at block 370, the MPLS label stack 210 of the received data frame. According to at least one example embodiment, determining whether the received data frame is a MPLS data frame may be optional or may be performed by another device other than the network device parsing the MPLS label stack 210. In other words, upon receiving a data frame, the network device may parse the MPLS label stack 210 assuming that all received data frames are MPLS data frames 200a, 200b. Upon detecting a MPLS encryption label 215c in the parsed MPLS label stack 210, the network device 114a, 114b decrypts the payload 220 of the received data frame and removes the detected MPLS encryption label 215c from the MPLS label stack 210 of the received data frame 200b, at block 380.

In decrypting the payload 220, the network device 114a, 114b employs information in an ESP header included in the received data frame 200b. In fact, the presence of the MPLS encryption label 215c is to indicate to the decrypting device the presence of the ESP header. The ESP header is removed from the data frame once payload decryption is performed. According to at least one example embodiment, the detected MPLS encryption label 215c is located at the bottom of the MPLS label stack 210, i.e., the last label within the MPLS label stack 210. In such case, when the MPLS encryption label 215c is removed, the method 300b via the network device 114a, 114b sets the BOS entry 218 of the MPLS label, e.g., 215b, located right before (preceding in the stack) the removed MPLS encryption label 215c to indicate that the respective MPLS label 215b, is now the last label within the MPLS label stack 210. However, if the MPLS label stack 210 becomes empty, the network device 114a, 114b may change the type of data frame, e.g., to IPv4 data frame type, and/or migrate a time to live (TTL) header from the removed MPLS encryption label 215c to another header or segment within the data frame 200a. Upon decrypting the payload 220 and removing the MPLS encryption label 215c, the network device 114a, 114b may forward the data frame 200a to another network entity, e.g., provider edge router 112a or 112b.

An example data path may be described as H1→R2→E1→R3→R4→E2→R5→H2, where H1 and H2 are IPv4 host devices, e.g., personal computers, while R2, R3, R4, and R5 are MPLS routers/switches 116. The devices E1 and E2 are MPLS encryption/decryption devices, e.g., 114a-b. First, the device H1 sends an IPv4 data packet destined for the device H2. The device R2 finds an MPLS path and pushes a Tunnel label T1 215a on the MPLS label stack 210 and changes the packet's EtherType 206 to MPLS (0x8847). Upon receiving the data packet, the device E1 appends the Encryption Label (12) 215c to the label stack. The MPLS label stack 210 now includes the MPLS label T1 215a, and the MPLS label (12) 215c. The device E1 then forwards the packet to the device R3. The device R3 performs MPLS label switching and changes the MPLS label stack 210 to include the label T2 215a, instead of T1, and the MPLS encryption label (12) 215c. In other words, the MPLS label switching performed by the device R3 involves replacing the MPLS tunnel label T1 with another MPLS tunnel label T2. The device R3, then, forwards the packet to the device R4.

Upon receiving the data packet, the device R4 also performs MPLS label switching, e.g., replacing the MPLS tunnel label T2. According to an example embodiment, the device R4 notices that the outgoing MPLS tunnel label, to replace the MPLS tunnel label T2, has a value equal to “3,” which means an implicit-null-label according to MPLS standards. The response behavior to an implicit-null-label is to not push the MPLS tunnel label on to the MPLS label stack 210. Accordingly, the device R4 forwards the data packet with the MPLS label stack 210 including only the encryption label (12) 215c. The device E2 receives the encrypted MPLS packet and detects the MPLS encryption label (12) 215c in the MPLS label stack 210. The device E2 then removes the ESP header from the packet and uses the information therein to perform decryption of the payload 220. On successful completion of decryption, the device E2 removes the MPLS encryption label (12) 215c from the MPLS label stack 210 and notices that the MPLS label stack 210 is now empty. Given that the MPLS label stack 210 is now empty, the data packet is not considered an MPLS data packet anymore and the device E2 does not forward the packet with Ethertype set to MPLS. As such, the device E2 updates the Ethertype to IPv4 (0x0800) and forwards the packet. The device R5, then, receives the IPv4 packet with Ethertype set to IPv4 and performs an IPv4 routing look up and forwards the data packet to the device H2, the intended destination of the IPv4 packet.

In the case where implicit-null-label, or Penultimate Hop Popping (PHP), is not used, the device R4 pushes the packet with the MPLS label stack 210 including a tunnel label T3 215a, instead of T2, and the MPLS encryption label (12) 215c. In such case the value of T3 is different from the value 3 discussed above. The device E2 then removes the MPLS encryption label (12) 215c and the ESP header and forwards the packet to R5. As such, the device R5 first performs an MPLS lookup, followed by an IPv4 lookup, to send the packet to the device H2. The use of the implicit-null-label, or PHP, avoids the extra MPLS look up that would otherwise be performed by R5.

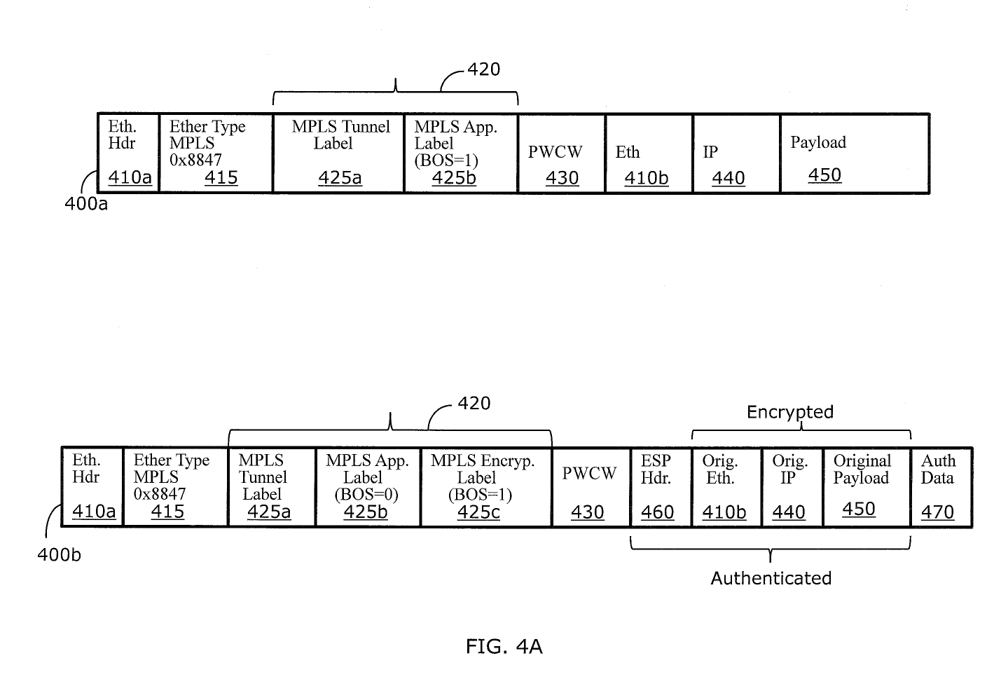

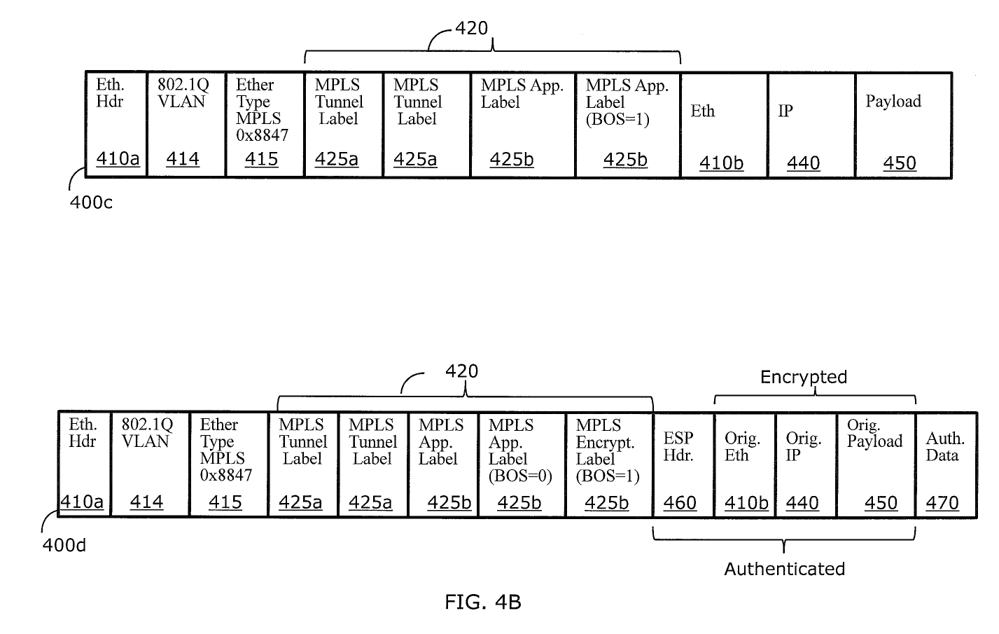

FIGS. 4A and 4B are graphical representations of different encrypted MPLS data frames and the respective non-encrypted MPLS data frames. In FIG. 4A, the non-encrypted data frame 400a includes, for example, an Ethernet header 410a, an Ethernet type entry 415, a MPLS label stack 420, a Pseudowire Control Word (PWCW) 430, a copy of the original Ethernet header 410b, a copy of the original Internet Protocol (IP) header 440 associated with the data frame, and the original payload 450. As shown in the corresponding encrypted MPLS data frame 400b, the copy of the original Ethernet header 410b and the copy of the IP header 440 are encrypted with the original payload 450. Encrypting the copy of the original Ethernet header 410b and the copy of the IP header 440 with the original payload 450 enables the decrypting device, e.g., 114a or 114b, to have access to such headers when decrypting the payload 450.

The Pseudowire Control Word (PWCW) 430, in the data frames 400a and 400b, is a typically a four-byte data field. The PWCW may follow the MPLS label-stack 420 within the data frame, e.g., 400a or 400b. The PWCW is typically used by intermediate MPLS switches to perform Management functionality. The PWCW 430 identifies certain MPLS traffic as control traffic. It typically has a value of zero for regular data traffic. For management/control traffic, the PWCW field 430 usually has a non-zero value. Certain L2 (layer-two) framing protocols, e.g., Asynchronous Transfer Mode (ATM), enforce strict sequence of packets and the packet ordering is implemented via sequence numbers from the edge devices. These sequence numbers must be visible in the MPLS network 110. For a given frame, the sequence number is added in the PWCW following the MPLS label stack 210. By accessing the PWCW, the intermediate routers are able to handle the MPLS packets in the right sequencing. Since the intermediate routers make use of the sequence number information, the PWCW is left in the clear (unencrypted).

According to at least one example embodiment, when encrypting a data frame, the network device, e.g., 114a or 114b, checks a configurable skip-PWCW flag. If the skip-PWCW is configured, the network device will not encrypt the PWCW 430 and allow it to be sent in the clear. Note that the PWCW 430 is not part of the MPLS label stack 420 and it is usually placed after the last MPLS label, e.g., the MPLS encryption label 425c, within the MPLS label stack. At the decrypting device, e.g., 114a or 114b, when the MPLS data frame, e.g., 400b, is received and if skip-PWCW flag is configured, then the decrypting device, e.g., 114a or 114b, assumes the existence of a PWCW 430 after the MPLS encryption label 425c and performs decryption after excluding the PWCW 430. The use/presence of PWCW 430 in data frames may be indicated within the MPLS-based network 110 via an explicit configuration. In the MPLS switches, or routers, such configuration information is exchanged in the Control plane and programmed in the data plane.

In the non-encrypted MPLS data frame 400a, the MPLS label stack 420 includes two MPLS labels, e.g., the MPLS tunnel label 425a and the MPLS application label 425b. In the corresponding encrypted MPLS data frame 400b, the MPLS label stack 420 includes the MPLS encryption label 425c besides the MPLS labels 425a and 425b. Also, the encrypted MPLS data frame 400b, includes an ESP header 460, placed between the PWCW 430 and the encrypted portion of the data frame, and an authentication field 470. The authentication field 470 includes data to authenticate the encrypted data, e.g., 410b, 440, and 450, as well as the ESP header 460. A person skilled in the art should appreciate that the existence of an MPLS application label, e.g., 215b or 425b, within the MPLS label stack 210, 420 is not mandatory. For example, a MPLS data frame with a MPLS tunnel label, e.g., 215a or 425a, but no MPLS application label, e.g., 215b or 425b, indicate that the corresponding payload is an IPv4 payload.

FIG. 4B shows graphical representations of a non-encrypted MPLS data frame 400c and the corresponding encrypted MPLS data frame 400d. Both, the encrypted and non-encrypted MPLS data frames 400c and 400d do not include PWCW 430.

The methods 300a and 300b may be performed by the encryption/decryption device, e.g., 114a or 114b. Alternatively, each of the methods 300a and 300b may be implemented as a module within provider edge routers, e.g., 112a-b, or another apparatus of the network 100. For example, the methods 300a and 300b may be implemented as software module(s), hardware module(s), firmware module(s), or a combination thereof. According to at least one example embodiment, the methods 300a and 300b may be implemented as instructions stored in a memory and executed by a processor of a given apparatus (or one or more elements) in the communications network 100. In another embodiment, a computer program product comprise a non-transitory computer readable medium with computer code instructions stored thereon. The computer code instructions when executed by a processor cause one or more network 100 elements to perform the methods 300a, 300b described above.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-based method of multi-protocol label switching (MPLS) data encryption, comprising:
determining whether a received data frame is a MPLS data frame; and
upon determining that the received data frame is a MPLS data frame,
encrypting a payload of the MPLS data frame while keeping a MPLS label stack of the MPLS data frame non-encrypted, and
inserting a MPLS encryption label, indicative of encryption of the payload, within the MPLS label stack of the MPLS data frame.

2. A method according to claim 1 further comprising inserting an encapsulating security payload (ESP) header in the MPLS data frame.

3. A method according to claim 1, wherein inserting the MPLS encryption label includes:
scanning the MPLS label stack of the MPLS data frame to determine a last label in the MPLS label stack;
inserting the MPLS encryption label, indicative of encryption of the MPLS payload, following the last label determined; and
arranging an indicator, indicative of the bottom of the MPLS label stack, to be located within the MPLS encryption label inserted.

4. A method according to claim 1 further comprising transmitting the MPLS data frame over a MPLS network.

5. A method according to claim 1 further comprising:
checking whether a skip pseudowire control word (PWCW) flag is configured; and
upon determining that the skip PWCW flag is configured, maintaining a PWCW non-encrypted within the received data frame.

6. An apparatus for multi-protocol label switching (MPLS) data encryption, comprising:
at least one processor; and
at least one memory operatively coupled to the processor and configured to cause the apparatus to:
determine whether a received layer-two data frame is a MPLS data frame; and
upon determining that the received layer-two data frame is a MPLS data frame,
encrypt a payload of the MPLS data frame while keeping a MPLS label stack of the MPLS data frame non-encrypted, and
insert a MPLS encryption label, indicative of encryption of the payload, within the MPLS label stack of the MPLS data frame.

7. An apparatus according to claim 6, wherein the at least one memory is configured to cause the apparatus to further insert an encapsulating security payload (ESP) header in the MPLS data frame.

8. An apparatus according to claim 6, wherein in inserting the MPLS encryption label, the at least one memory is configured to cause the apparatus to:
scan the MPLS label stack of the MPLS data frame to determine a last label in the MPLS label stack;
insert the MPLS encryption label, indicative of encryption of the MPLS payload, following the last label determined; and
arrange an indicator, indicative of the bottom of the MPLS label stack, to be located within the MPLS encryption label inserted.

9. An apparatus according to claim 6, wherein the at least one memory is configured to cause the apparatus to further transmit the MPLS data frame over a MPLS network.

10. An apparatus according to claim 6, wherein the at least one memory is configured to cause the apparatus to further:
check whether a pseudowire control word (PWCW) skip flag is configured; and
upon determining that the skip PWCW flag is configured, keep a PWCW, within the received data frame, non-encrypted.

11. A computer program product comprising:
a non-transitory computer-readable medium with computer code instructions, for multi-protocol label switching (MPLS) data encryption, stored thereon;
the computer code instructions when executed by a processor cause one or more communication network elements to:
determine whether a received layer-two data frame is a MPLS data frame; and
upon determining that the received layer-two data frame is a MPLS data frame,
encrypt a payload of the MPLS data frame while keeping a MPLS label stack of the MPLS data frame non-encrypted, and
insert a MPLS encryption label, indicative of encryption of the payload, within the MPLS label stack of the MPLS data frame.

12. A computer-based method of multi-protocol label switching (MPLS) data decryption, comprising:
determining, by a network device, whether a received data frame is a MPLS data frame; and
upon determining that the received data frame is a MPLS data frame,
parsing a MPLS label stack of the MPLS data frame, and
upon determining that the parsed MPLS label stack includes a MPLS encryption label, indicative of encryption of a payload of the MPLS data frame, decrypting the payload and removing the MPLS encryption label from the MPLS label stack.

13. A method according to claim 12 further comprising forwarding the data frame with decrypted payload to another network device.

14. A method according to claim 12, wherein the MPLS encryption label is the last label in the MPLS label stack.

15. A method according to claim 12, wherein decrypting the payload includes using an encapsulating security payload (ESP) header in the MPLS data frame.

16. A method according to claim 12, wherein removing the MPLS encryption label includes setting an indicator, indicative of the bottom of the MPLS label stack, to be on at a MPLS label preceding the MPLS encryption label in the MPLS data frame.

17. A method according to claim 12 further comprising changing type of the data frame upon determining that the MPLS label stack is empty as a result of removing the MPLS encryption label.

18. A method according to claim 17 further comprising migrating a time to live (TTL) header from the MPLS encryption label removed to another header of the data frame.

19. A method according to claim 12 further comprising:
checking whether a skip pseudowire control word (PWCW) flag is configured; and
upon determining that the skip PWCW flag is configured, configuring the payload of the MPLS data frame in a way that a PWCW, within the received data frame, is excluded from the payload.

20. An apparatus for multi-protocol label switching (MPLS) data decryption, comprising:
at least one processor; and
at least one memory operatively coupled to the processor and configured to cause the apparatus to:
determine whether a received data frame is a MPLS data frame; and
upon determining that the received data frame is a MPLS data frame,
parse a MPLS label stack of the MPLS data frame, and
upon determining that the parsed MPLS label stack includes a MPLS encryption label, indicative of encryption of a payload of the MPLS data frame, decrypt the payload and remove the MPLS encryption label from the MPLS label stack.

21. An apparatus according to claim 20, wherein the at least one memory is configured to cause the apparatus to further forward the data frame with decrypted payload to another network device.

22. An apparatus according to claim 20, wherein the MPLS encryption label is the last label in the MPLS label stack.

23. An apparatus according to claim 20, wherein in decrypting the payload the at least one memory and the at least one memory is configured to cause the apparatus to use an encapsulating security payload (ESP) header in the MPLS data frame.

24. An apparatus according to claim 20, wherein in removing the MPLS encryption label, the at least one memory is configured to cause the apparatus to set an indicator, indicative of the bottom of the MPLS label stack, to be on at a MPLS label preceding the MPLS encryption label in the MPLS data frame.

25. An apparatus according to claim 20, wherein the at least one memory is configured to cause the apparatus to further change type of the data frame upon determining that the MPLS label stack is empty as a result of removing the MPLS encryption label.

26. An apparatus according to claim 25, wherein the at least one memory is configured to cause the apparatus to further migrate a time to live (TTL) header from the MPLS encryption label removed to another header of the data frame upon determining that the MPLS label stack is empty as a result of removing the MPLS encryption label.

27. An apparatus according to claim 20, wherein the at least one memory is configured to cause the apparatus to further:
check whether a skip pseudowire control word (PWCW) flag is configured; and
upon determining that the skip PWCW flag is configured, configure the payload of the MPLS data frame in a way that a PWCW, within the received data frame, is excluded from the payload.

28. A computer program product comprising:
a non-transitory computer-readable medium with computer code instructions, for multi-protocol label switching (MPLS) data decryption, stored thereon; and
the computer code instructions when executed by a processor cause one or more communication network elements to:
determine whether a received data frame is a MPLS data frame; and
upon determining that the received data frame is a MPLS data frame,
parse a MPLS label stack of the MPLS data frame, and
upon determining that the parsed MPLS label stack includes a MPLS encryption label, indicative of encryption of a payload of the MPLS data frame, decrypt the payload and remove the MPLS encryption label from the MPLS label stack.
